(19) United States
(12) Patent Application Publication
(10) Pub. No.: US 2017/0247168 A1
(43) Pub. Date: Aug. 31, 2017

(54) INSTANT COOKING HEATING BAG

(71) Applicant: Jeong-Mae KIM, Gwangju (KR)

(72) Inventor: Jeong-Mae KIM, Gwangju (KR)

(21) Appl. No.: 15/321,200

(22) PCT Filed: Jan. 5, 2015
(86) PCT No.: PCT/KR2015/000039

§ 371 Date: May 1, 2017

(30) Foreign Application Priority Data
Sep. 3, 2014 (KR) 10-2014-0117006

(51) Int. Cl. B65D 81/34; B65D 75/58; B65D 75/00; A47J 36/24; B65D 75/38; A47J 27/00; A47J 36/28; B65D 33/25; B65D 75/70

(52) U.S. Cl. CPC B65D 81/3484; B65D 33/2508; B65D 75/5805; B65D 75/008; B65D 75/70; B65D 75/38; A47J 27/002; A47J 36/28; A47J 36/2494

(57) ABSTRACT

The present invention relates to an instant cooking heating bag and, more specifically, to an instant cooking heating bag of which an inner bag, in which food is to be accommodated, is put into an outer bag so as to be integrally formed by the binding of the inner bag with the outer bag, provided with a heating agent and an aqueous solution bag in a space formed between the outer bag and the inner bag, and provided with a cutting means connected to the aqueous solution bag, so as to allow food to be heated and cooked instantly by a user's simple manipulation of pulling the cutting means, thereby allowing warm food to be conveniently consumed outdoors without using additional cooking utensils. An instant cooking heating bag according to the present invention comprises: an outer bag of which the upper part is open and the lower part is closed such that the upper end part is bound so as to seal the inside of the outer bag in a state in which contents are accommodated therein; an inner bag accommodated inside the outer bag such that the upper part thereof is open and the lower part thereof is closed, thereby allowing food to be accommodated therein and providing an opening/closing zipper at the opening of the open upper part; and a heating agent accommodated in a heating space formed between the outer bag and the inner bag and generating heat by reacting with an aqueous solution, and the instant cooking heating bag further comprises: an aqueous solution bag accommodated in the heating space and in which an aqueous solution, causing the reaction of the heating agent, is put; and a cutting means of which one end is connected to one side of the aqueous solution bag so as to cut the aqueous solution bag by being pulled by an external force, wherein the border of one side of the aqueous solution bag is bound to the inner surface of the outer bag along a first binding line.

### TECHNICAL FIELD

The present invention relates to an instant cooking heating bag, and more particularly, to an instant cooking heating bag in which an inner bag for accommodating food is arranged in and integrally bonded to an outer bag, an exothermic agent and an aqueous solution bag are provided in a space defined between the outer bag and the inner bag, and a cutting means connected to the aqueous solution bag is provided to allow the user to heat and cook food on the spot by simply pulling the cutting means to easily prepare warm food outdoors without using separate cooking means.

### BACKGROUND ART

In Korean cuisine, the proportion of foods which are heated and cooked ranging from rice, which is the main food, to various kinds of stew and soup is very high. For this reason, when food is prepared during leisure activities mainly performed outdoors, a portable burner is very often used to cook the food.

However, as cooking by means of fire is prohibited in many places such as mountains and parks for reasons of environmental protection and fire prevention, outdoor activities frequently require preparation of food that does not require a cooking process using fire.

In recent years, as living standards have improved, people's interest in health and leisure has increased. As outdoor activities, such as mountain climbing, fishing, and sports, have become increasingly available, demand for portable food such as ready-to-eat lunch boxes, bread, sandwiches, and canned drinks that can be easily purchased at convenience and grocery stores and be easily eaten outdoors without a cooking process using fire is increasing.

However, in cold weather, such portable foods have had to be eaten in a cold state since fire cannot be used to warm the foods.

If such portable foods are eaten in a cold state, the taste of the foods cannot be properly enjoyed, and coldness of the foods may even cause stomachache.

In order to solve the aforementioned problems, a portable food heating container that allows food to be easily and safely warmed and eaten outdoors has recently been developed.

One example is disclosed in Korean Utility Model No. 20-0420155 (registered on Jun. 22, 2006) entitled “A throwaway heat envelope using a heating element.” According to this document, a heating element is placed in a disposable heating bag of a specific volume, and water is poured into the bag to heat food or the like using heat of about 100° C. generated during hydration reaction of the exothermic agent.

In this disposable heating bag, a space for accommodating a heating element and water is formed, but a space for accommodating food is not separately formed. Therefore, to put and cook food in the disposable heating bag, the food needs to be put in a separate container or a plastic bag and sealed or to be wrapped to prevent contamination of the food by a product of reaction between the heating element and water or the residue.

In addition, when heat is generated with the disposable heating bag sealed to reduce heat loss, the bag may expand and rupture due to the pressure of the steam generated by heat.

In order to solve the above problems, a “portable heating cooker” of Korean Utility Model No. 20-2010-0009406 (published on Sep. 29, 2010) has been proposed in the prior art.

The aforementioned prior art document discloses a portable heating cooker in which a separate inner bag capable of containing food therein is housed in an outer bag and integrally attached to the outer bag.

In this portable heating cooker, the opening located at the upper portion of the outer bag is closed by an opening/closing zipper to form a closed heating chamber in the outer bag, and a hole for discharging steam is formed in the upper side portion of the outer bag in preparation for sudden pressure expansion due to the hydration reaction of the exothermic agent and water.

However, the conventional portable heating cooker as described above is provided with a separate inlet for introduction of an exothermic agent and water and a separate zipper for opening and closing the inlet, and thus it is difficult to manufacture the portable heating cooker. Moreover, the separately provided inlet is formed as small as possible to ensure that the cooker is closed, which is disadvantageous in that it is inconvenient to introduce the exothermic agent and water.

In addition, the conventional portable heating cooker described above has a structure in which a hole for discharging steam is pre-formed in the upper portion of the outer bag. Thereby, air may flow into and out of the outer bag during distribution, and accordingly the exothermic agent needs to be packed separately so as not to react with the moisture contained in the air during distribution, and it is inconvenient to remove the package at the time of use.

### DISCLOSURE

### Technical Problem

Therefore, the present invention has been made in view of the above problems, and it is one object of the present invention to provide an instant cooking heating bag having an outer bag, an inner bag for accommodating food contained in the outer bag and integrally bonded to the outer bag, and a heat generation space defined between the outer bag and the inner bag and provided with an exothermic agent and an aqueous solution bag. With the instant cooking heating bag, a separate aqueous solution for reacting with the exothermic agent is not required and a cutting means connected to one side of the aqueous solution bag is provided so as to cut the aqueous solution bag. Accordingly, the instant cooking heating bag allows a user to easily heat, cook and ingest food by simply pulling cutting means.

It is another object of the present invention to provide an instant cooking heating bag in which a heat generation space is sealed by bonding an outer bag to an inner bag to prevent moisture in the air from flowing into the heating bag in a packaged state, and a part of the bonding lines of the outer bag and the inner bag are separated to form a steam outlet when a cutting means is pulled, such that moisture in the air is prevented from contacting the exothermic agent in the packaged state and the steam generated when the food is heated is discharged through the newly formed steam outlet. Thereby, the instant cooking heating bag may be prevented from rupturing due to the pressure of the steam.

### Technical Solution

In accordance with one aspect of the present invention, provided is an instant cooking heating bag including an outer bag having an open upper portion and a closed lower portion and configured to seal an inner portion thereof by bonding an upper end portion with content contained therein, an inner bag accommodated in the outer bag to contain content therein and having an open upper portion and a closed lower portion, an opening of the open upper portion being provided with an opening/closing zipper, and an exothermic agent accommodated in a heat generation space defined between the outer bag and the inner bag to react with an aqueous solution to generate heat, the instant cooking heating bag including: an aqueous solution bag accommodated in the heat generation space and containing the aqueous solution to react with the exothermic agent; and a cutting means having one end connected to one side of the aqueous solution bag to cut the aqueous solution bag when the one end is pulled by external force, wherein an edge of one side of the aqueous solution bag is bonded to an inner surface of the outer bag along a first bonding line.

The edge of one side of the aqueous solution bag is provided with a skirt extending to bond the edge to the inner surface of the outer bag, and one side of the skirt in a longitudinal direction of the skirt is provided with a cutting piece cut out by a predetermined width to facilitate cutting of the aqueous solution bag.

In addition, a center portion of the cutting piece is provided with a connection hole allowing one end of the cutting means to be fitted thereinto, wherein the cutting means has a stick shape and is provided with an engagement piece formed at both sides of the cutting means in a width direction to prevent the one end fitted into the connection hole from being displaced from the connection hole when an opposite end of the cutting means is pulled and a fixing projection spaced a predetermined distance from the engagement piece and formed at both sides of the cutting means and to fix a position of the one end fitted into the connection hole, wherein the opposite end is provided with an oval pull ring having a sharp end allowing a user to easily hook and pull the pull ring with a finger.

The pull ring is disposed across a second bonding line for bonding the outer bag and the inner bag such that a part of the pull ring is exposed to an upper space defined between an upper end portion of the outer bag and the opening/closing zipper of the inner bag, and is integrally bonded by thermocompression along the second bonding line up to an inside of the pull ring.

Further, when the part of the pull ring exposed to the upper space is pulled out, a steam outlet for discharging steam generated during exothermic reaction is formed while an inner bonding portion of the pull ring is separated from the second bonding line.

### Advantageous Effects

As apparent from the foregoing description, an instant cooking heating bag according to the present invention has an inner bag for accommodating food contained in an outer bag and integrally bonded to the outer bag, and an exothermic agent and an aqueous solution bag are provided together in a heat generation space defined between the outer bag and the inner bag. A separate aqueous solution for reacting with an exothermic agent is not required to be supplied and a cutting means connected to one side of the aqueous solution bag is provided so as to cut the aqueous solution bag. Accordingly, the instant cooking heating bag allows a user to easily heat, cook and ingest food by simply pulling the cutting means.

According to an embodiment of the present invention, an instant cooking heating bag maintains a heat generation space in a sealed state by bonding an outer bag to an inner bag to prevent moisture in the air from flowing into the heating bag in a packaged state, and a part of the bonding lines of the outer bag and the inner bag are separated to form a steam outlet when a cutting means is pulled, such that moisture in the air is prevented from contacting the exothermic agent in the packaged state and the steam generated when the food is heated is discharged through the newly formed steam outlet. Thereby, the instant cooking heating bag may be prevented from rupturing due to the pressure of the steam.

### DESCRIPTION OF DRAWINGS

FIG. 1 is a front view of an instant cooking heating bag according to an embodiment of the present invention;

FIG. 2 is a cross-sectional view of an instant cooking heating bag according to an embodiment of the present invention.

FIG. 3 is a perspective view showing the exterior of the instant cooking heating bag of FIG. 1, which is cut along a cut-out groove.

FIG. 4 is a schematic view illustrating a process of cutting an aqueous solution bag and a process of forming a steam outlet in an instant cooking heating bag according to an embodiment of the present invention.

FIG. 5 is a schematic view illustrating a process of combining an aqueous solution bag and a cutting means of an instant cooking heating bag according to an embodiment of the present invention.

FIG. 6 is a schematic cross-sectional view taken along the line A-A′ in FIG. 3(a).

### BEST MODE

Hereinafter, an instant cooking heating bag (hereinafter, referred to as “heating bag”) according to embodiments of the present invention will be described in detail with reference to the accompanying drawings.

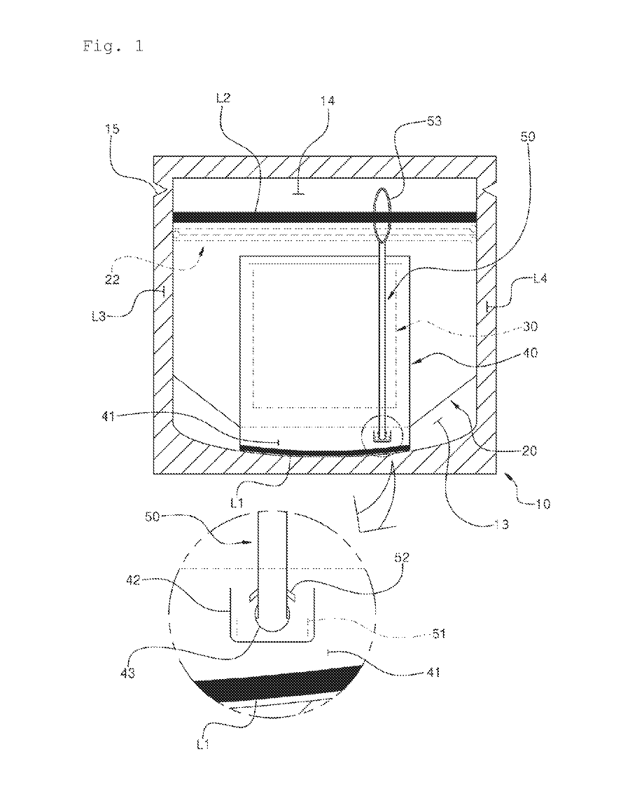

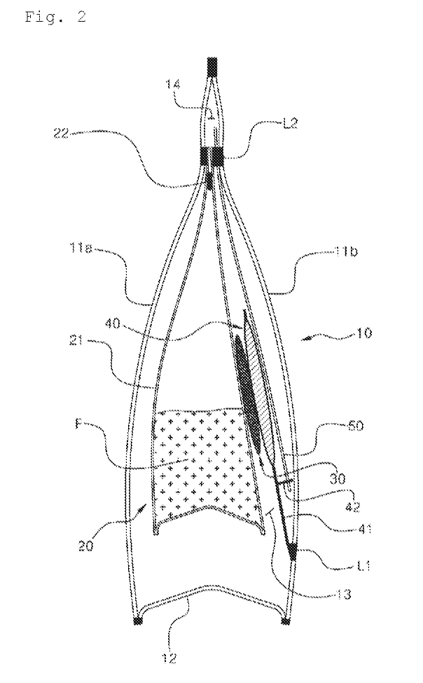

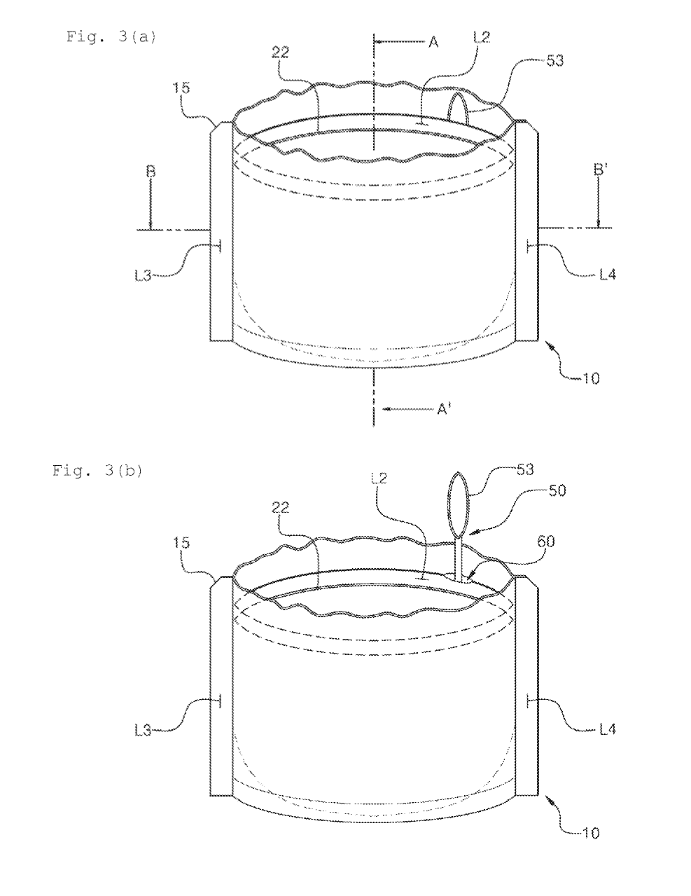

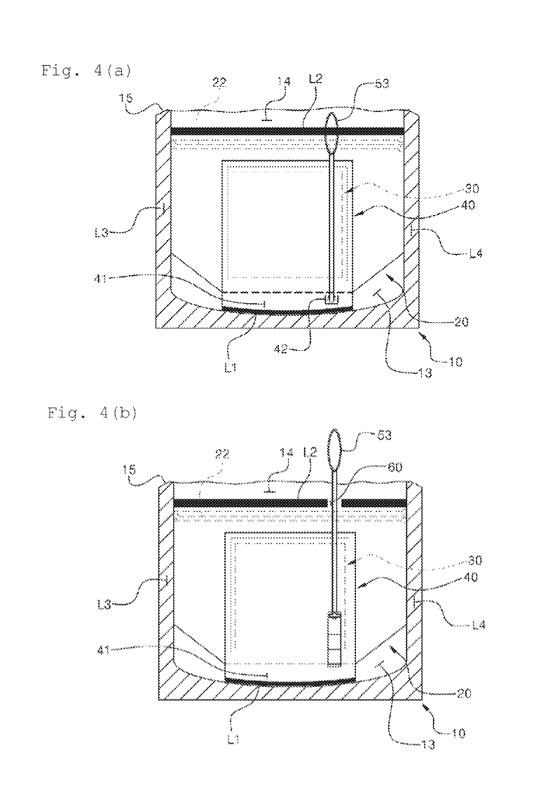

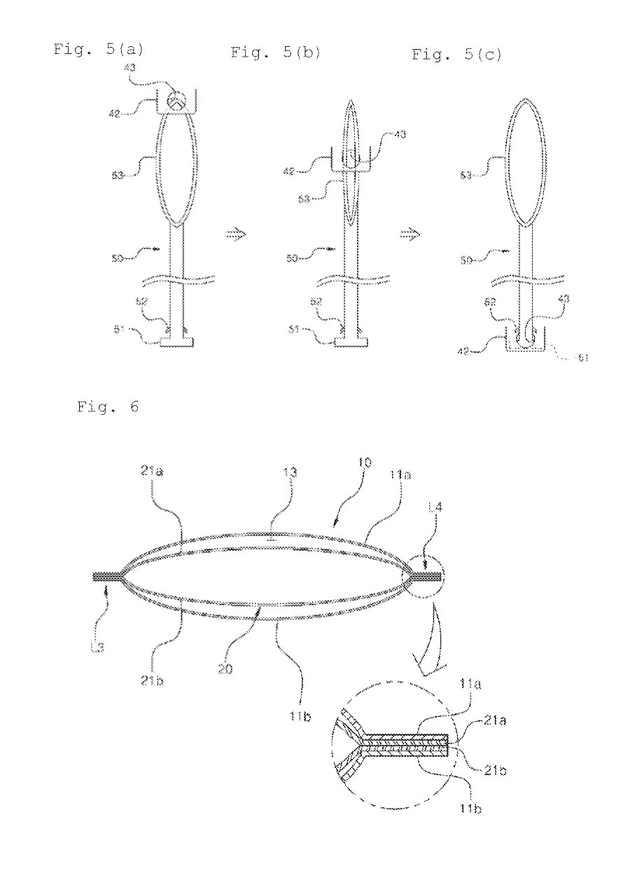

FIG. 1 is a front view of a heating bag according to an embodiment of the present invention. FIG. 2 is a cross-sectional view of a heating bag according to an embodiment of the present invention. FIG. 3 is a perspective view showing the exterior of the heating bag of FIG. 1, which is cut along a cut-out groove. FIG. 4 is a schematic view illustrating a process of cutting an aqueous solution bag and a process of forming a steam outlet in a heating bag according to an embodiment of the present invention. FIG. 5 is a schematic view illustrating a process of combining an aqueous solution bag and a cutting means of a heating bag according to an embodiment of the present invention. FIG. 6 is a schematic cross-sectional view taken along the line A-A′ in FIG. 3(a).

Referring to the figures, the heating bag according to the present invention includes an outer bag 10, an inner bag 20, an exothermic agent 30, an aqueous solution bag 40 and a cutting means 50. A steam outlet 60 is formed in the heating bag as a user pulls the cutting means 50 to heat food F.

The outer bag 10 is configured such that an upper portion thereof is opened and a lower portion thereof is closed, and is sealed by bonding an upper end portion thereof with content contained therein. The outer bag 10 is made of a heat-resistant vinyl material.

As shown in FIG. 2, the outer bag 10 is formed by two outer sheets 11a and 11b. The outer sheets 11a and 11b are bonded to each other at the left and right edges thereof. The lower portion of the outer bag 10 is closed by bonding an outer lower sheet 12 to the lower ends of the two outer sheets 11a and 11b, and the upper portion of the outer bag 10 is open. The interior of the outer bag 10 is sealed by thermocompression bonding of the inner edge surface of the open upper end thereof with the inner bag 20, the exothermic agent 30, the aqueous solution bag 40 and the cutting means 50 accommodated therein.

The overall volume of the outer bag 10 may be reduced by folding the outer lower sheet 12 when the outer bag 10 is distributed or unused. When the food F is heated, the outer bag 10 may be immovably placed on the floor by unfolding the outer lower bag 12.

The aqueous solution bag 40 is bonded to one side of the inner surface of the outer bag 10 along a first bonding line L1.

As shown in FIG. 1, the outer bag 10 has cut-out grooves 15 formed at opposite edges of the upper end portion thereof to face each other in the inward direction, such that the user can easily cut and open the outer bag 10.

The inner bag 20 is accommodated in the outer bag 10. The upper portion of the inner bag 20 is open and the lower portion thereof is closed to accommodate the food F therein and an opening/closing zipper 22 is provided to the opening of the open upper portion. The inner bag 20 is made of the same heat-resistant vinyl material as the outer bag 10.

As shown in FIG. 2, in one embodiment of the present invention, the inner bag 20 is formed in the shape of an envelope which is open at the upper portion thereof and closed at the lower portion thereof by folding one inner sheet 21 having a length considerably longer than the width thereof in half and bonding the left and right edges thereof arranged in the width direction. An opening/closing zipper 22 is provided in the opening of the open upper portion of the inner bag 20 so as to seal or open the inner bag 20.

Meanwhile, the inner bag 20 may have a folded structure in which the lower end portion folded in half is pushed to a certain depth from the outside, such that the folded portion of the lower end portion is unfolded to form a lower end surface of a certain area.

As the lower end portion of the inner bag 20 is formed as described above, the user can widen the inner space of the inner bag 20 by unfolding the lower end portion of the inner bag 20. Thereby, the user may conveniently eat the food F.

The inner bag 20 is accommodated in and bonded to the outer bag 10, thereby defining a heat generation space 13 between the inner bag 20 and the outer bag 10.

In an embodiment of the present invention, the heat generation space 13 is defined as the inner bag 20 accommodated in the outer bag 10 is integrated with the outer bag 10 by bonding the outer surfaces of both sides of the upper edge of the inner bag 20 to the inner surfaces of both sides of the upper portion of the outer bag 10.

Preferably, the heat generation space 13 is maintained in a sealed state in order to prevent moisture in the air from flowing into the heat generation space 13 to react with the exothermic agent 30 during distribution and storage.

The exothermic agent 30, the aqueous solution bag 40 and the cutting means 50 are accommodated in the heat generation space 13.

As shown in FIG. 6, in an embodiment of the present invention, the outer bag 10 and the inner bag 20 are formed by overlapping two outer sheets 11a and 11b and two inner sheets 21a and 21b, respectively. The four sheets 11a, 11b, 21a and 21b constituting the outer bag 10 and the inner bag 20 have the same width, and the left and right edges of the four sheets 11a, 11b, 21a and 21b are integrally bonded along a third bonding line L3 and a fourth bonding line L4 with the two inner sheets 21a and 21b of the inner bag 20 interposed between the outer sheets 11a and 11b of the outer bag 10. Thereby, the outer bag 10 and the inner bag 20 are integrated and the manufacturing process of the present invention may be greatly simplified.

The exothermic agent 30 is accommodated in the heat generation space 13 defined between the outer bag 10 and the inner bag 20 and reacts with the aqueous solution to generate heat. The exothermic agent 30 may be formed of a metal exothermic agent such as an ordinary aluminum exothermic agent, or an exothermic agent made of quicklime powder may be used.

The exothermic agent 30 may be provided in the form of a heating element pack wrapped in a nonwoven fabric such as a nonwoven fabric.

The aqueous solution bag 40 is accommodated in the heat generation space 13 defined between the outer bag 10 and the inner bag 20 and contains an aqueous solution to react with the exothermic agent 30. The aqueous solution bag 40 is formed by a sealed wrapper made of a vinyl material and preferably has a certain durability that prevents the wrapper from being ruptured by external force generated during distribution and storage, such that the aqueous solution does not flow out.

The aqueous solution contained in the aqueous solution bag 40 may be pure water, and a catalyst may be added to the pure water to further enhance the effect of reaction with the exothermic agent 30.

As shown in FIG. 2, one side edge of the aqueous solution bag 40 is bonded and fixed to the inner surface of the outer bag 10 along the first bonding line L1. Herein, the edge is preferably bonded by thermocompression bonding.

Since the aqueous solution bag 40 is bonded and immovably fixed to the inner surface of the outer bag 10, the user can easily cut the aqueous solution bag 40 by pulling the cutting means 50.

A skirt 41 extends along one side edge of the aqueous solution bag 40 so as to be bonded to the inner surface of the outer bag 10, and a cutting piece 42 cut out by a predetermined width is formed at one longitudinal side of the skirt 41 to facilitate cutting of the aqueous solution bag 40.

The skirt 41 is formed for the purpose of securing a sufficient bonding surface and length for bonding the aqueous solution bag 40 to the inner surface of the outer bag 10 and for the purpose of securing a space for forming the cutting piece 42.

The cutting piece 42 is connected to one end of the cutting means 50 and is configured such that the user can easily cut the aqueous solution bag 40 by pulling the cutting means 50.

As shown in FIG. 1, the cutting piece 42 is formed in a bracket shape being open upward and having a predetermined width, such that both leading ends of the cutoff line are formed to face the inside of the aqueous solution bag 40.

Meanwhile, the center portion of the cutting piece 42 is provided with a connection hole 43 into which one end of the cutting means 50 is fitted and connected.

The cutting means 50 is configured such that one end thereof is connected to one side of the aqueous solution bag 40 and is pulled by an external force to cut the aqueous solution bag 40. The cutting means is generally formed in the shape of a stick having a specific length. The one end of the cutting means is provided with an engagement piece 51 and fixing protrusions 52, and the other end thereof is provided with a pulling ring 53.

The cutting means 50 is preferably formed of an elastic material which is deformable by external force. In an embodiment of the present invention, the cutting means 50 is formed of a synthetic resin material which is elastically deformable.

The engagement piece 51 is formed at one end of the cutting means 50 in opposite width directions to prevent one end of the cutting means 50 fitted into the connection hole 43 from being displaced from the connection hole when the other end of the cutting means 50, namely, the pull ring 53, is pulled.

In an embodiment of the present invention, as shown in FIG. 1, the one end of the cutting means 50 having the engagement piece 51 is formed in an upside-down T-shape.

The fixing projections 52 are spaced a predetermined distance from the engagement piece 51 and formed on both sides of the cutting means in a width direction so as to fix the position of the one end of the cutting means 50 with the one end fitted into the connection hole 43.

In an embodiment of the present invention, as shown in FIG. 1, the fixing projections 52 are spaced a predetermined distance from one end of the cutting means 50 having the engagement piece 51 toward the other end of the cutting means and protrude from both sides in the width direction so as to be inclined downward.

The one end of the cutting means 50 may be fixed at a specified position by the fixing projection 52 without being displaced in the direction opposite to the direction in which the cutting means 50 is inserted.

That is, once the one end of the cutting means 50 is installed in the connection hole 43, the cutting means 50 is maintained in a fixed position by the engagement piece 51 and the fixing projections 52, not being displaced in any direction.

The pull ring 53 is provided at the other end of the cutting means 50. The pull ring 53 is formed in a ring shape to allow the user to easily pull the pull ring with a finger, and has an oval shape with a sharp upper end.

The pull ring 53 is formed of an elastic material that is deformable by external force. In an embodiment of the present invention, the pull ring 53 is formed of an elastically deformable synthetic resin.

As shown in FIG. 5, the pull ring 53 has a ring-shaped cross section having a thin thickness, and accordingly has a predetermined elasticity when it is formed of a thin synthetic resin material.

As shown in FIG. 1, a part of the pull ring 53 is configured to be exposed to an upper space 14 defined between the upper end portion of the outer bag 10 and the opening/closing zipper of the inner bag 20. With this configuration, the user may easily recognize the position of the pull ring 53 and pull the pull ring 53 by holding the pull ring with a finger.

The pull ring 53 is disposed on the second bonding line L2 along which the outer bag 10 and the inner bag 20 are bonded, and bonding of the outer bag 10 and the inner bag 20 is integrally formed up to the inside of the pull ring 53 along the bonding line L2 by thermocompression bonding. Thereby, a part of the pull ring 53 may be exposed to the upper space 14, while the heat generation space 13 is maintained in a sealed state.

In addition, as the pull ring 53 is fixed at the predetermined position though bonding as described above, the conventional inconvenience of requiring the user to find and pull a pulling string in the form of a string, which has been mainly used as the conventional pulling means, may be addressed.

The cutting means 50 configured as described above is inserted into the connection hole 43 formed in the cutting piece 42 and is coupled with the aqueous solution bag 40.

The process of coupling the aqueous solution bag 40 and the cutting means 50 will be briefly described below with reference to FIG. 5.

First, one side end of the pull ring 53 on the long axis is fitted into the connection hole 43, and pushed until it completely penetrates the connection hole 53.

For reference, as shown in FIG. 5(b), since the one side end of the pull ring 53 on the long axis is formed to be pointed, the pull ring 53 can be easily fitted into the connection hole 43, whose diameter is smaller than the width of the pull ring 53 on the short axis of the pull ring 53. In addition, since the pull ring 53 is formed of an elastically deformable material with an overall thin oval shape, the pull ring 53 can pass through the connection hole 43 as it is elastically deformed and narrowed in the direction of the short axis.

At this time, the pull ring 53 is hooked and pulled beyond the fixing projections 52 by a finger until the engagement piece 51 is engaged with the connection hole 43 and is not moved any more.

In this way, coupling of the cutting means 50 and the aqueous solution bag 40 is completed.

Thereby, the cutting means 50 may be fixed in position by the fixing projections 52 protruding downward to be inclined and is not displaced from the position in the direction opposite to the direction in which the cutting means 50 is fitted, as shown in FIG. 5(c).

The heating bag according to the present invention is configured such that a steam outlet 60 for discharging steam generated in the exothermic reaction is not formed in normal times, namely during distribution and storage, but is formed when the user pulls the pull ring 53 to heat food F.

That is, as shown in FIGS. 3 and 4, the steam outlet 60 is formed as the inner bonding portion of the pull ring 53 on the second bonding line L2 is separated when the pull ring 53 partially exposed to the upper space 14 is pulled.

In other words, the steam outlet 60, which is a small passage for discharging steam, is formed according to separation of the bonding portion of the second bonding line L2 bonded inside the pull ring 53 by pulling the pull ring 53 when the heat generation space 13 is maintained in a sealed state by integrally bonding the outer bag 10 and the inner bag 20 along the second bonding line L2 with the pull ring 53 interposed between the inner surface of one side of the upper portion of the outer bag 10 and the outer surface of one side of the upper portion of the inner bag 20.

Hereinafter, usage of the heat generation bag according to an embodiment of the present invention will be briefly described with reference to the drawings.

As shown in FIG. 3(a), when the user cuts the upper portion of the outer bag 10 along the incision groove 15 formed in the upper portion of the outer bag 10, the upper space 14 in the sealed state is opened, and the opening/closing zipper 22 of the inner bag 20 and a part of the pull ring 53 exposed above the second bonding line L2 are visible.

In this state, the opening/closing zipper 22 of the inner bag 20 is opened, and the dried food F and the appropriate water provided into the inner bag 20 are mixed. Then, the opening/closing zipper 22 is zipped up again to seal the inner bag 20.

Thereafter, when the user hooks and pulls a part of the pull ring 53 exposed above the second bonding line L2 using a finger as shown in FIG. 4(a), the aqueous solution bag 40 is broken along the cutting piece 42 connected to one end of the cutting means 50, and the aqueous solution contained in the aqueous solution bag 40 flows out and permeates the exothermic agent 30, immediately generating high heat through exothermic reaction. The food F contained in the inner bag 20 is heated and cooked by the high heat.

During the exothermic reaction, the outer bag 10 may be rapidly expanded due to the steam generated by the instantaneously generated heat. However, the outer bag 10 has durability to withstand the expansion pressure due to the characteristics of the material constituting the outer bag 10, and the steam is discharged little by little through the steam outlet 60 formed by separation of a part of the second bonding line L2 when the pull ring 53 is pulled, as shown in FIGS. 3(b) and 4(b). Accordingly, a problem such as rupture of the outer bag 10 does not occur.

The heating bag according to the present invention configured as above may be sold with the food F packaged therein or sold without the food F. In addition, the heating bag prevents the exothermic agent 30 from being exposed to external moisture, which causes functional degradation and obstructs the exothermic agent from reacting, and accommodates both the exothermic agent 30 and the aqueous solution bag 40. Accordingly, the user may easily heat, cook and eat the food F through simple operations.

In addition, the steam generated during cooking of the food F can be discharged through the steam outlet 50 defined between the outer bag 10 and the inner bag 20 by pulling the pull ring 53 of the cutting means 50. Accordingly, the bag may be prevented from rupturing due to the pressure of the steam, and thus the user can safely use the bag.

The instant cooking heating bag described above and shown in the drawings is only one embodiment for carrying out the present invention and should not be construed as limiting the spirit of the present invention. The scope of protection of the present invention is defined only by the appended claims, and it is to be understood that modifications and variations made in the present invention without departing from the gist of the present invention are within the scope of protection of the present invention.

### REFERENCE NUMERALS

10 Outer bag
11 Outer sheet
12 External bottom sheet
13 Heating space part
14 Upper space
15 Incision groove
20 Inner bag
21 Inner sheet
22 Opening/closing zipper
30 Exothermic agent
40 Aqueous solution bag
41 Skirt
42 Cutting piece
43 Connection hole
50 Cutting means
51 Engagement piece
52 Fixing projection
53 Pull ring
60 Steam outlet
L1 First bonding line
L2 Second bonding line
L3 Third bonding line
L4 Fourth bonding line
F Food

What is claimed is:

1. An instant cooking heating bag including an outer bag having an open upper portion and a closed lower portion and configured to seal an inner portion thereof by bonding an upper end portion with content contained therein, an inner bag accommodated in the outer bag to contain content therein and having an open upper portion and a closed lower portion, an opening of the open upper portion being provided with an opening/closing zipper, and an exothermic agent accommodated in a heat generation space defined between the outer bag and the inner bag to react with an aqueous solution to generate heat, the instant cooking heating bag comprising:
an aqueous solution bag accommodated in the heat generation space and containing the aqueous solution to react with the exothermic agent; and
a cutting means having one end connected to one side of the aqueous solution bag to cut the aqueous solution bag when the one end is pulled by external force,
wherein an edge of one side of the aqueous solution bag is bonded to an inner surface of the outer bag along a first bonding line.

2. The instant cooking heating bag according to claim 1, wherein the edge of one side of the aqueous solution bag is provided with a skirt extending to bond the edge to the inner surface of the outer bag, and one side of the skirt in a longitudinal direction of the skirt is provided with a cutting piece cut out by a predetermined width to facilitate cutting of the aqueous solution bag.

3. The instant cooking heating bag according to claim 2, wherein a center portion of the cutting piece is provided with a connection hole allowing one end of the cutting means to be fitted thereinto,
wherein the cutting means has a stick shape and is provided with an engagement piece formed at both sides of the cutting means in a width direction to prevent the one end fitted into the connection hole from being displaced from the connection hole when an opposite end of the cutting means is pulled and a fixing projection spaced a predetermined distance from the engagement piece and formed at both sides of the cutting means and to fix a position of the one end fitted into the connection hole,
wherein the opposite end is provided with an oval pull ring having a sharp end allowing a user to easily hook and pull the pull ring with a finger.

4. The instant cooking heating bag according to claim 3, wherein the pull ring is disposed across a second bonding line for bonding the outer bag and the inner bag such that a part of the pull ring is exposed to an upper space defined between an upper end portion of the outer bag and the opening/closing zipper of the inner bag, and is integrally bonded by thermocompression along the second bonding line up to an inside of the pull ring.

5. The instant cooking heating bag according to claim 4, wherein, when the part of the pull ring exposed to the upper space is pulled out, a steam outlet for discharging steam generated during exothermic reaction is formed while an inner bonding portion of the pull ring is separated from the second bonding line.
